(19) United States
(12) Patent Application Publication
(10) Pub. No.: US 2013/0251877 A1
(43) Pub. Date: Sep. 26, 2013

(54) SNACK PRODUCTS AND METHOD FOR PRODUCING SAME

(71) Applicants: Barry C. Levin, City of Industry, CA (US); Joseph M. Papiri, La Habra Heights, CA (US)

(72) Inventors: Barry C. Levin, City of Industry, CA (US); Joseph M. Papiri, La Habra Heights, CA (US)

(73) Assignee: SNAK KING CORPORATION, City of Industry, CA (US)

(21) Appl. No.: 13/430,054

(22) Filed: Mar. 26, 2012

(51) Int. Cl. A23P 1/14; A21D 13/00; A23L 1/217; A23L 1/10

(52) U.S. Cl. 426/559; 426/445; 426/450; 426/447

(57) ABSTRACT

Snack products and methods for producing snack products comprising a mixture of an expandable base product and one or more relatively non-expandable inclusions. The base product may comprise a pelletized or non-pelletized wheat, potato, corn, rice, other flours, starches, and grains, vegetables, and/or mixes thereof. The inclusions may comprise one or more types of herbs and spices, vegetables, fruits, meats, beans, grains, or other ingredients. The mixture is processed using an expansion machine (or “puffing machine”) that is operative to cook and expand the mixture to form a snack product, such as a chip, cracker, cake, or the like.

### BACKGROUND OF THE INVENTION

1. Field of the Invention

The present invention is directed generally to snack products, and more particularly to systems and methods for producing puffed or popped snack products including one or more base products and one or more inclusions.

2. Description of the Related Art

Snack foods have long been a household staple around the world and range from treats to dietary supplements. However, recently a nutrition trend found candy and other naturally and artificially sweetened confections, as well as potato chips, pretzels, corn chips, and the like, being replaced by healthier products. The terms “low fat,” “no-fat,” and “light” have become popular words in the snack food industry. Pressure-baking and expanding a starch-containing raw food material into puffed or “popped” crackers, cakes, chips and similar snacks, which is usually carried out between the heated dies of a closable mold, has now become a popular technology in the field of manufacturing healthy snack products having relatively low fat content.

### BRIEF DESCRIPTION OF THE SEVERAL VIEWS OF THE DRAWINGS

FIG. 1 is a block diagram of a snack product production system in accordance with an embodiment of the present invention.

FIG. 2 is a flow chart depicting a process for producing a snack product using the snack product production system of FIG. 1.

FIGS. 3A illustrates a cross-sectional elevational view of a portion of an expansion machine that depicts a first step in a sequence of steps for a process for expanding the snack product using the expansion machine.

FIGS. 3B illustrates a cross-sectional elevational view of a portion of an expansion machine that depicts a second step in a sequence of steps for a process for expanding the snack product using the expansion machine.

FIGS. 3C illustrates a cross-sectional elevational view of a portion of an expansion machine that depicts a third step in a sequence of steps for a process for expanding the snack product using the expansion machine.

FIGS. 3D illustrates a cross-sectional elevational view of a portion of an expansion machine that depicts a fourth step in a sequence of steps for a process for expanding the snack product using the expansion machine.

FIGS. 3E illustrates a cross-sectional elevational view of a portion of an expansion machine that depicts a fifth step in a sequence of steps for a process for expanding the snack product using the expansion machine.

FIGS. 3F illustrates a cross-sectional elevational view of a portion of an expansion machine that depicts a sixth step in a sequence of steps for a process for expanding the snack product using the expansion machine.

### DETAILED DESCRIPTION OF THE INVENTION

### Overview

Embodiments of the present invention are directed to systems and methods for producing snack products comprising a mixture of an expandable base product and one or more relatively non-expandable inclusions. The mixture is processed using an expansion machine (or “puffing machine”) that is operative to bake and expand the mixture to form a snack product, such as a chip, cracker, cake, or the like.

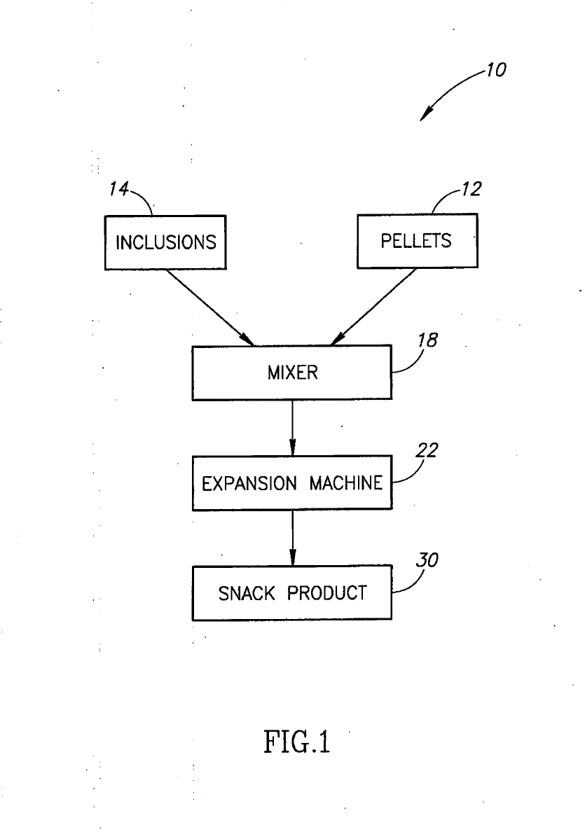

FIG. 1 is a block diagram of a snack product production system 10 in accordance with an embodiment of the present invention. Generally, the system 10 comprises a mixer 18 and a grain processor or expansion machine 22. The mixer 18 may comprise any suitable device operative to mix combinations of grains and additional inclusions. As an example, the mixer 18 may comprise a ribbon blender that includes a trough and one or more sets of ribbon agitators.

The expansion machine 22 is a machine that converts expandable grains and/or pellets into a chip, cake, biscuit, or cracker (hereinafter “snack product”). Generally, the expansion machine 22 receives from the mixer 18 expandable raw materials into a mold, which then closes, compresses and bakes the materials for a short period, after which an opening in the mold is created to enable the expansion of the material, thus forming snack product 30. By way of a non-limiting example, a suitable expansion machine 22 is a PELLEX® grain processor manufactured by INCOMEC CEREX, Brakel, Belgium.

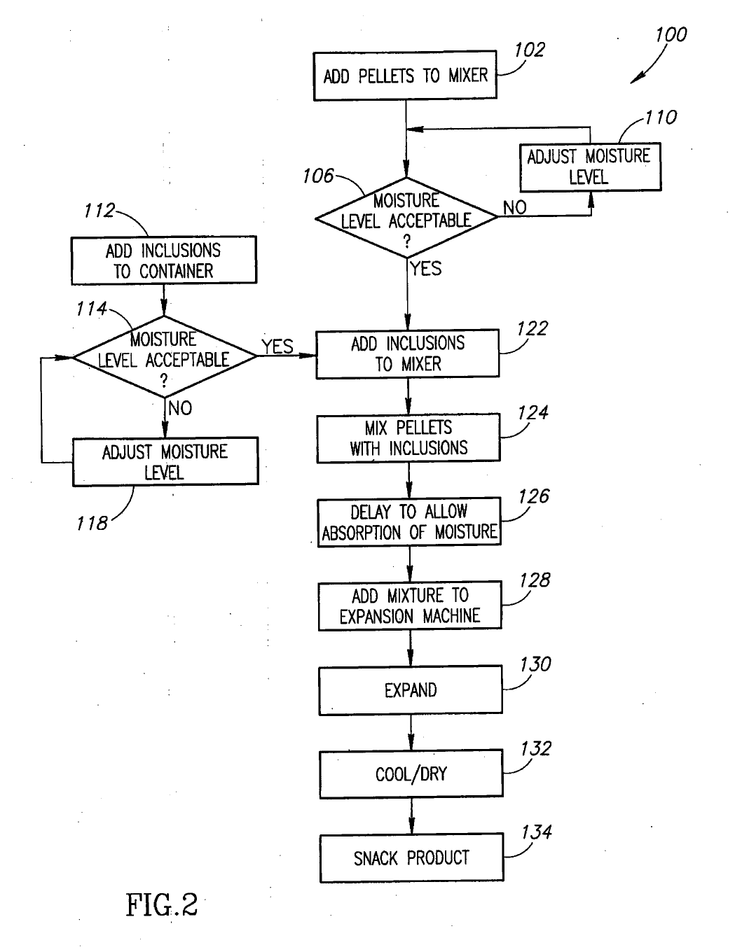

As shown in FIG. 1, a quantity of expandable material such as expandable pellets 12 and a quantity of relatively non-expandable inclusions 14 are used as the raw materials for producing the snack product 30. Although the term “pellets” is used herein for explanatory purposes when referring to the base product, it should be appreciated that the expandable material used for the base product may comprise one or more types of pelletized or non-pelletized materials. Generally, the pellets 12 and the inclusions 14 are mixed together by the mixer 18, and then fed into the expansion machine 22 to form the snack product 30. The process for producing the snack product 30 is discussed in further detail below with reference to FIG. 2.

The pellets 12 may comprise numerous types of expandable pelletized or non-pelletized products made from wheat, potato, corn, rice, other flours, starches, and grains, vegetables, and/or mixes thereof. The materials used for forming the pellets 12 may be pelletized, non-pelletized, ground, chopped, or any other shape or size. As another example, the pellets 12 may comprise expandable kernels of popcorn. Generally, the expandable base product or pellets 12 may expand by a relatively large factor when processed in the expansion machine 22. For example, the expandable pellets 12 may expand by a factor of between 40% up to 1000%, or even greater, during the expansion process. Further, the pellets 12 may also include one or more complementary ingredients including, but not limited to, beans, fruit, vegetables, sweeteners, bioactives, flavors and colors, salts, etc. In some embodiments, the pellets 12 may be formed using a cooking extruder. This device includes a long screw within a heated housing. The motion of the screw mixes the raw materials and moves this mixture through the extruder, cooking it as it moves along. At the end of the cooking extruder, the cooked dough emerges as a ribbon. A rotating knife may then cut the ribbon into the pellets 12, which comprise an extruded food starch material. As an example, suitable pellets 12 are produced and sold by J. R. Short Milling Co., Kankakee, Ill..

The inclusions 14 mixed with the pellets 12 in the mixer 18 may comprise a variety of types of ingredients. The following is a non-exhaustive list of ingredients that may be used alone or in various combinations for the inclusions 14:
Herbs and spices: seaweed, garlic, basil, cinnamon, rosemary, cilantro, onion, and kale
Vegetables: peas, broccoli beads, green bean, tomato, red bell pepper, green bell pepper, carrot, shallot, spinach, potato, sweet potato, kale, and beets
Fruits: banana, berries, apple, cherry, mangos, and kiwi
Meat: bacon, beef, jerky, pepperoni, salami, and fish
Beans: black beans, pinto beans, kidney beans, navy beans, lentils, and coffee
Grains: rice, brown or white, whole or broken, wheat, de-germen broken corn, broken corn, rye, oats, buckwheat, soy bean, millet, barley, sesame, amaranth, quinoa, flaxseed, and chia
Other: crustaceans, hard candy, nuts, and peppers, fungi, and color dyes
   The amount of inclusions 14 mixed with the base product or pellets 12 may vary dependent on the type of inclusions 14 used. In some embodiments, the inclusions 14 may comprise less than 5% (e.g., 0.2% to 0.5%, 0.1% to 5%, or the like) of the overall mixture by weight. In some embodiments, the inclusions 14 may comprise up to 50% of the mixture by weight. Further, the size of the inclusions 14 may be varied as desired. For example, in some embodiments, the inclusions may have a dimension that is larger than the largest dimension of the pellets 12 themselves.

FIG. 2 is a flow chart depicting a process 100 for producing the snack product 30 using the snack product production system 10 of FIG. 1. At block 102, the expandable pellets 12 are added to the mixer 18. Then, the moisture level of the pellets 12 is checked and adjusted to a predetermined desired moisture level, blocks 106 and 110. In some embodiments, the moisture level of the pellets 12 is adjusted to achieve a desired moisture level of approximately 13% to 14%, but other moisture levels may also be used (e.g., 2% to 20%, 10% to 18%, etc.). The moisture level of the pellets 12 may be monitored using any suitable moisture meter. As an example, a suitable moisture meter is the Protimeter Grainmaster® sold by General Electric Co. In addition to adjusting the moisture level of the pellets 12, a small amount (e.g., less than 5%, between 0.1 to 0.2%, or the like) of a releasing agent (e.g., lecithin, other oil, etc.) may be added to the pellets to reduce the likelihood that the snack product 30 will stick to a component of the expansion machine 22 during the expansion process. Additionally or alternatively, other oils such as sunflower oil or rice oil may be used.

Concurrently, the inclusions 14 may be added to a separate container, block 112, and their moisture level may also be checked and adjusted, blocks 114 and 118. In some embodiments, the moisture level of the inclusions 14 is adjusted to achieve a desired moisture level of approximately 15% to 16%, but other moisture levels may also be used (e.g., 2% to 20%, 10% to 30%, etc.).

Further, if multiple different types of pellets 12 or multiple different types of inclusions 14 are used, it is recommended that their moisture levels be adjusted separately because different ingredients may have different water absorbing characteristics.

Once the moisture levels of both the pellets 12 and the inclusions 14 have been adjusted to the desired levels, e.g., 13-14% and 15-16%, respectively, the inclusions may be added into the mixer 18 and the pellets and inclusions may be mixed for a period of time (e.g., 15 to 20 minutes, etc.), blocks 122 and 124. After the mixing step, the resulting mixture of pellets 12 and inclusions 14 may be given a period of time (e.g., 1 to 1.5 hours) to allow them to absorb the added moisture.

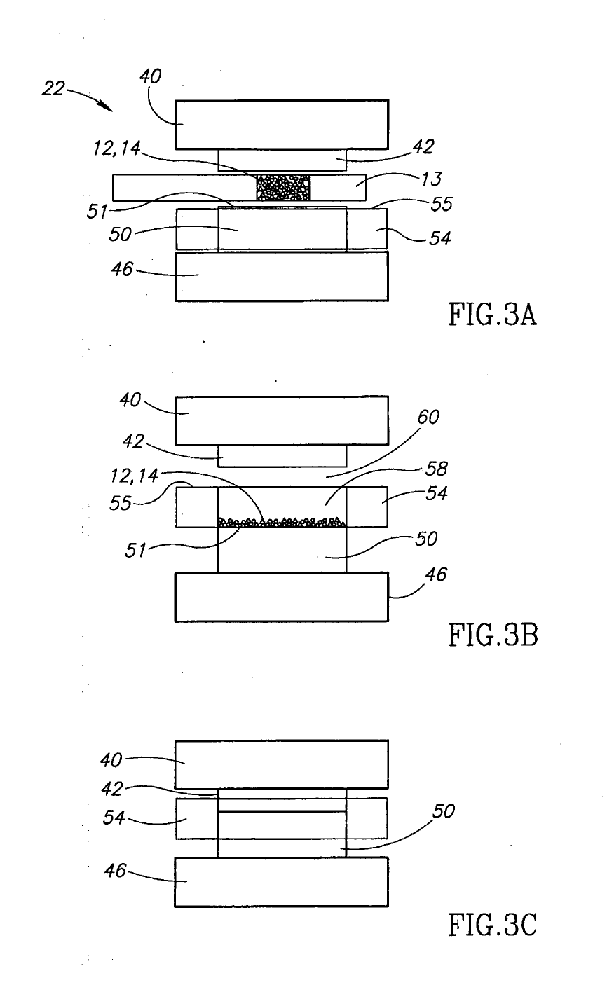

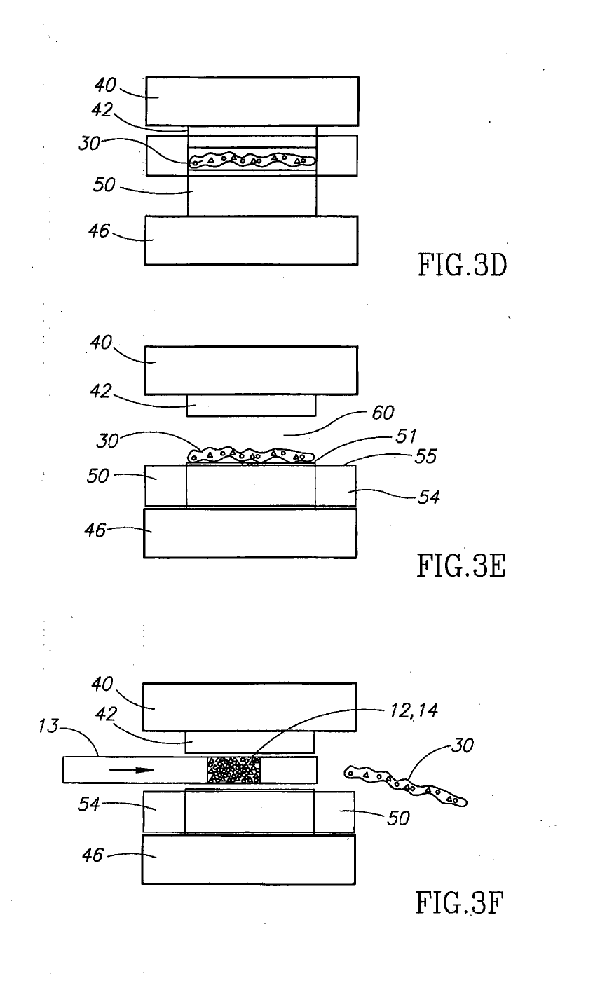

Next, the mixture of pellets 12 and inclusions 14 may be fed into the expansion machine 22, wherein the mixture is baked and expanded, blocks 128 and 130. The operation of the expansion machine 22 is described in detail below with reference to FIGS. 3A-3F. Finally, the expanded product may be cooled and/or dried to provide the snack product 30, blocks 132 and 134.

FIGS. 3A-3F illustrate an exemplary operational sequence and die movements for the expansion machine 22. The expansion machine 22 may comprise a multi-die arrangement for the production of numerous snack products simultaneously. For example, in some embodiments, the expansion machine 22 utilizes 28 die assemblies (or molds) to make 28 snack products at a time. For illustrative purposes, only a single die assembly or mold is depicted in FIGS. 3A-3F. The expansion machine 22 may comprise a heated stationary upper die plate 40 having a plurality of fixed downwardly directed upper die elements 42.

Vertically spaced below the stationary upper die plate 40 there is provided a heated die plate (or punch plate) 46 with multiple upwardly directed lower punch elements 50. The punch plate 46 is supported on a movable carrier element (not shown) operative to move the punch plate vertically upward and downward. The fixed upper die element 42 and the movable lower punch element 50 are disposed in a vertically aligned relationship.

A movable ring mold element (or “ring die”) 54 is arranged between the die plates 40 and 46, and comprises a hole 58 which is aligned with the upper die element 42 and also with the lower punch element 50. As shown in FIGS. 3E and 3F, the ring die 54 may be oriented in a lower position wherein it rests on the movable lower die plate 46 such that the lower punch element 50 is penetrating the hole 58 of the ring die. The vertical movement of the ring die 54 may be actuated by a mover, such as a pneumatic or hydraulic cylinder (not shown). Similarly, the lower die plate 46 may be movable by a drive system coupled thereto. By way of an example, the movement of the ring die 54 and the lower die plate 46 may be controlled by a programmable logic controller (PLC), or the like.

In FIGS. 3A and 3B, the feeding of a mixture of expandable pellets 12 and inclusions 14 into a baking mold is illustrated. A sliding plate 13 loaded with the mixture 12, 14 enters a gap 60 (see FIG. 3B) between the upper die element 42 and the movable lower punch element 50, the latter being then in a lowered, snack product “push-out” position wherein a top surface 51 of the lower punch element extends just above an upper rim 55 of the equally lowered ring die 54, such that a previously prepared snack product 30 is pushed away (see FIG. 3F) by feeding the sliding plate 13. In FIG. 3B, the lower punch element 50 is moved downward so as to form, within the ring die hole 58, a filling cup into which the feeding slide plate 13 supplies a predetermined amount of the raw material mixture 12, 14. In FIG. 3C, both the heated lower punch element 50 and the heated ring die 54 are moved upwards and the materials mixture 12, 14 is heated and compressed between the upper die element 42 and the lower punch element 50, which define a sealed die cavity together with the ring die 54. This baking position may be maintained for a few seconds to gelatinize the mixture 12, 14.

In FIG. 3D, the ring die 54 is kept in its raised position sealed against upper die element 42, but the lower punch element 50 is rapidly moved downward towards a lower position still confined within the ring die, thereby defining a predetermined expansion volume. As a result of the sudden pressure drop, the gelatinized and heat-softened expandable pellets 12 together with released gases (steam) will explosively expand in the downward direction so as to form a self-sustaining puffed snack product 30. During this step, the pellets 12 expand and surround or “weave” around the inclusions 14 to form the snack product 30. Generally, the mold may expand from the compressed position to the expanded position in approximately 2 to 7.5 seconds, or the like.

In FIG. 3E, the ring die 54 is lowered over the lower punch element 50 to a mold opening position wherein the snack product 30 rests on the top surface 51 of the lower punch element and can be discharged by a leading edge face of the feeding slide plate 13 engaging and pushing the snack product clear of the expansion machine 22, as depicted in FIG. 3F of the process sequence. The process may then repeat to produce another snack product.

In some embodiments, the process cycles may be extended and optimized by incorporating one or more additional partial or full expansion or compression steps. As an example, the process cycle may include two or three sequential expansion and compression steps to form each snack product 30.

The temperature, pressure time, and baking time may be varied as desired to produce the snack product 30. In some embodiments, the upper die element 42 and the lower punch element 50 are heated to a temperature of between 215 to 325 degrees Centigrade (C), for example, 300° C. In some embodiments, the snack product 30 may be baked for approximately 1 second to 12 seconds (e.g., 1.8 seconds, 5.0 seconds, 7.5 seconds, 10.0 seconds, etc.), and pressure may be applied for approximately 0.05 seconds to 3 seconds, or the like. It will be appreciated that other temperatures, pressure times, and baking times may also be used.

The snack product 30 produced according to the process 100 described above has a desirable texture, taste, and visual appearance compared to previously made products. For example, compared to snack products that are made using only expandable pellets (with or without additional ingredients therein), the texture of the snack products 30 of the present invention is much less uniform due to the presence of both the expanded pellets 12 and the relatively non-expandable inclusions 14 distributed throughout. Additionally, in some embodiments, the inclusions 14 are visually distinguishable from the pellets 12 in the final snack product 30, which may add a certain degree of attractiveness to the snack product. The pellets and mixes of grains and inclusions and/or pellets may be converted into a slice, cake, biscuit, or cracker in multiple shapes (e.g., round, triangle, square, etc.). Further, in some embodiments the dimensions may be approximately 25 mm to approximately 50 mm, with a weight of approximately 7 to 25 grams per ten chips. Other dimensions and weights may also be used.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A method of producing a snack product, comprising:
providing a quantity of an expandable base product;
providing a quantity of relatively non-expandable inclusions different from the base product;
mixing the base product and the inclusions together to form a mixture;
exposing the mixture to an increased pressure and temperature inside a chamber; and
rapidly expanding the volume of the chamber to cause a rapid expansion of the base product to form a snack product comprising the mixture of the expanded base product and the inclusions.

2. The method of claim 1, wherein the inclusions comprise approximately 0.2% to 5% of the overall mixture by weight.

3. The method of claim 1, wherein the inclusions comprise less than 50% of the overall mixture by weight.

4. The method of claim 1, wherein the base product is formed from one or more ingredients selected from a list of ingredients comprising: wheat, potato, corn, and rice.

5. The method of claim 1, wherein the base product is formed from one or more grains.

6. The method of claim 1, wherein the base product is formed from one or more vegetables.

7. The method of claim 1, wherein the inclusions comprise one or more ingredients selected from a list of ingredients comprising: herbs and spices, vegetables, fruits, meats, beans, and grains.

8. The method of claim 1, further comprising measuring the moisture level of the base product and adjusting the moisture level to a desired moisture level.

9. The method of claim 8, wherein the desired moisture level for the base product is between 10% and 18%.

10. The method of claim 1, further comprising measuring the moisture level of the inclusions and adjusting the moisture level to a desired moisture level.

11. The method of claim 10, wherein the desired moisture level for the inclusions is between 10% and 18%.

12. The method of claim 1, further comprising adding a releasing agent to the base product in an amount such that the releasing agent comprises less than 5% of the combined weight of the mixture of the releasing agent and the base product.

13. The method of claim 1, wherein the quantity of inclusions comprises two or more different types of inclusions.

14. The method of clam 1, wherein the snack product comprises one of a chip, cake, biscuit, or cracker.

15. The method of claim 1, further comprising increasing the pressure in the chamber after expanding the volume of the chamber.

16. The method of claim 1, wherein the temperature in the chamber is between approximately 215 to 325 degrees Centigrade.

17. The method of claim 1, wherein the increased pressure in the chamber is applied for approximately 0.05 seconds to 3 seconds.

18. The method of claim 1, wherein the expandable base product is formed from pellets comprising an extruded food starch material.

19. The method of claim 18, wherein the inclusions each have a dimension larger than the largest dimension of the pellets.

20. The method of claim 1, wherein the expandable base product comprises kernels of popcorn.

21. The method of claim 20, wherein the inclusions each have a dimension larger than the largest dimension of the kernels of popcorn.

22. The method of claim 1, wherein the chamber is expanded over a period of approximately 2 to 7.5 seconds.

23. An expanded snack product, comprising:
a quantity of expanded pellets formed from an extruded food starch material; and
a quantity of inclusions, wherein the snack product is formed by mixing the pellets and the inclusions together to form a mixture, placing the mixture in a chamber, then exposing the mixture to an increased pressure and temperature in the chamber, then rapidly expanding the volume of the chamber thereby expanding the pellets to form a snack product comprising the mixture.

24. The snack product of claim 23, wherein the inclusions comprise approximately 0.2% to 5% of the overall weight of the snack product after it is formed.

25. The snack product of claim 23, wherein the pellets are formed from one or more ingredients selected from a list of ingredients comprising: wheat, potato, corn, and rice.

26. The snack product of claim 23, wherein the pellets are formed from one or more grains.

27. The snack product of claim 23, wherein the pellets are formed from one or more vegetables.

28. The snack product of claim 23, wherein the inclusions comprise one or more ingredients selected from a list of ingredients comprising: herbs and spices, vegetables, fruits, meats, beans, and grains.

29. A method of producing a snack product, comprising:
providing a quantity of an expandable base product comprising one or more ingredients selected from a list of ingredients comprising: wheat, potato, corn, and rice;
adjusting the moisture level of the expandable base product to a desired moisture level;
providing a quantity of relatively non-expandable inclusions comprising one or more ingredients selected from a list of ingredients comprising: herbs and spices, vegetables, fruits, meats, beans, and grains;
adjusting the moisture level of the inclusions to a desired moisture level;
mixing the expandable base product and the inclusions together to form a mixture;
exposing the mixture to an increased pressure and temperature inside a chamber; and
rapidly expanding the volume of the chamber over a period of approximately 2 to 7.5 seconds to cause a rapid expansion of the base product to form a snack product comprising the mixture of the expanded base product and the inclusions.
